(19) United States
(12) Patent Application Publication
(10) Pub. No.: US 2008/0048828 A1
(43) Pub. Date: Feb. 28, 2008

(54) KEYLESS OPERATING SYSTEM AND METHOD FOR VEHICLE

(75) Inventor: Frank Buccinna, Livonia, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/463,688

(22) Filed: Aug. 10, 2006

(51) Int. Cl. B60R 25/00

(52) U.S. Cl. 340/5.72; 307/10.4; 340/5.54; 340/5.31

(57) ABSTRACT

The embodiments described herein include a keyless operating system and method for a vehicle. The system includes a user input device for receiving a first and a second user input. A control module communicates with the user input device and is configured to receive the first user input from the user input device. The control module is further configured to determine whether the first user input corresponds to a first code and generate signals that enable vehicle entry if the first user input corresponds to the first code. The control module is also configured to receive the second user input from the user input device. The control module is configured to determine whether the second user input corresponds to a second code and generate signals that enable starting of a vehicle engine if the second user input corresponds to the second code.

### TECHNICAL FIELD

The present invention relates to a keyless operating system for a vehicle.

### BACKGROUND

Keyless entry systems for vehicles are commonly available. In the conventional keyless entry system, a keyboard having a plurality of buttons is mounted to the vehicle. When a proper combination of keys or buttons is pressed, the vehicle doors are unlocked. In other conventional systems, a second keyboard may be mounted within the interior of the vehicle that allows for starting of the vehicle when the proper combination of keys is selected. Although these prior art systems are capable of unlocking and/or starting the vehicle, there exists a wide horizon for improvement. Particularly, the prior art systems require complex analog circuitry in addition to multiple keyboards for optimal operation. Accordingly, the prior art systems are inefficient and costly to design and implement.

Thus, the embodiments described herein were conceived in view of these and other disadvantages of conventional systems.

### SUMMARY

The embodiments described herein include a keyless operating system and method for a vehicle. The system includes a user input device for receiving a first and a second user input. A control module communicates with the user input device and is configured to receive the first user input from the user input device. The control module is further configured to determine whether the first user input corresponds to a first code and generate signals that enable vehicle entry if the first user input corresponds to the first code. The control module is also configured to receive the second user input from the user input device. The control module is configured to determine whether the second user input corresponds to a second code and generate signals that enable starting of a vehicle engine if the second user input corresponds to the second code.

The method for the keyless operating system includes receiving a first and a second user input from a user via a user input device. The method also includes determining whether the first user input corresponds to a first code through the use of a control module. The method further includes generating signals that enable vehicle entry if the first user input corresponds to the first code. The method also includes determining whether the second user input corresponds to a second code. Additionally, the method includes generating signals that enable starting of a vehicle engine if the second user input corresponds to the second code.

### BRIEF DESCRIPTION OF THE DRAWINGS

The features of the present invention which are believed to be novel are set forth with particularity in the appended claims. The present invention, both as to its organization and manner of operation, together with further advantages thereof, may be best understood with reference to the following description, taken in connection with the accompanying drawings in which:

FIG. 1 illustrates a vehicle having a keyless operating system in accordance with an embodiment of the present invention; and

FIG. 2 illustrates a flow chart of a method of operation for a keyless operating system in accordance with an embodiment of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

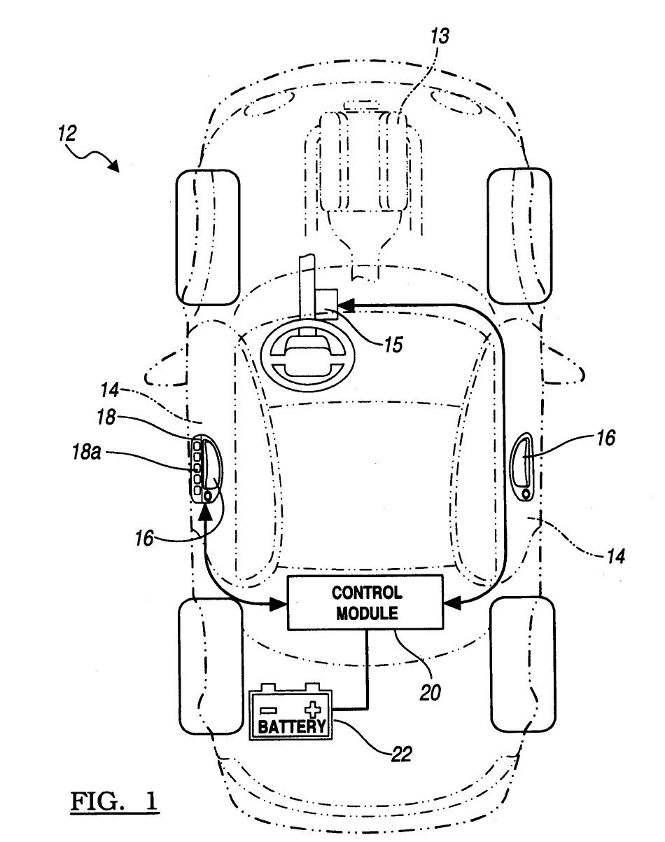

Referring to FIG. 1, a vehicle 12 is shown having a keyless operating system in accordance with a preferred embodiment of the present invention. Vehicle 12 includes an engine 13, a door 14, and an ignition 15. As shown in FIG. 1, door 14 includes a door handle 16 and a user input device 18. Conventionally, door 14 may be locked or unlocked to control entry into vehicle 12. User input device 18 is operable with door 14 to cause locking and/or unlocking of door 14. Accordingly, user input device 18 includes a plurality of buttons 18a. In a preferred embodiment, a user may press a predetermined sequence of buttons 18a and cause the door 14 to unlock without a key. When buttons 18a are pressed, a signal is generated that is received by a control module 20. As will be described hereinafter, control module 20 is configured to process the received signals and cause unlocking of door 14. As shown, control module 20 is coupled to a battery 22. Battery 22 serves as a power source for vehicle 12 including control module 20. In one embodiment, signals transmitted between user input device 18, control module 20, and ignition 15 may occur by wire or wirelessly. In a wireless communications embodiment, wireless protocols including, but not limited to bluetooth or wi-fi may be utilized.

In either embodiment, control module 20 may be a microprocessor having signal processing and memory storage functionality. Within the memory of control module 20, a series of codes are stored which enable the unlocking of doors 14 and ignition 15. Control module 20 is also configured to generate signals that cause unlocking of ignition 15. As recognized by one of ordinary skill in the art, engagement of ignition 15 causes engine 13 to start. In one embodiment, ignition 15 has a locked and unlocked state. In the unlocked state, ignition 15 is engageable by a user to start engine 13. In the locked state, the ignition 15 is locked and prevents starting of engine 13.

When a user selects a predetermined sequence of buttons 18a, signals from user input device 18 are received by control module 20. As such, the control module compares the entered sequence of buttons 18a with the codes stored within the memory of control module 20. If control module 20 determines that the entered code corresponds with the stored code for unlocking doors 14, doors 14 will be unlocked, thereby enabling entry into vehicle 12.

Additionally, control module 20 includes a timer for determining whether a predetermined time period has occurred before successive sequences are entered via user input device 18. In a preferred embodiment, a second code may be entered within the predetermined time period, which if correct, causes unlocking of unlocking of ignition 15. Preferably, although not necessarily, the predetermined time period may range from 5 to 15 seconds. If a correct second or subsequent code is not entered within the predetermined time period, the control module is configured to terminate the keyless operating program. Nevertheless, once the second user input is entered, within the predetermined time period and received by control module 20, control module 20 compares the second code to codes contained within the memory of control module 20. If the second code corresponds to or matches the codes stored within control module 20, a signal is generated by control module 20 that causes unlocking of ignition 15. Unlocking of ignition 15 will enable the vehicle operator or user to keylessly engage the ignition and start engine 13.

In a preferred embodiment, the ignition 15 includes a rotatable cylinder that is adapted to receive a key. In such an embodiment, assuming the correct sequence of buttons is pressed within the predetermined time period, the user may simply rotate the ignition cylinder thereby starting engine 13. Alternatively, ignition 15 may be embodied as a button, which may be activated upon the entry of correct codes. Engagement of the button causes starting of engine 13. It is recognized that other types of ignitions may vary from those described in the foregoing without departing from the scope of the present invention.

As a security measure, the timer of control module 20 may also determine whether the process for starting vehicle 12 has commenced within a second predetermined time period. For example, in one embodiment, the user should begin the process for starting the vehicle within approximately 20 seconds. In alternative embodiments, the predetermined time period may vary without departing from the scope of the invention. Nevertheless, if the starting process has not commenced within the predetermined time period, control module 20 generates signals that cause ignition 15 to enter the locked state. Accordingly, as described above, the user will not be able to keylessly engage ignition 15 and start vehicle 12 while ignition 15 is in the locked state.

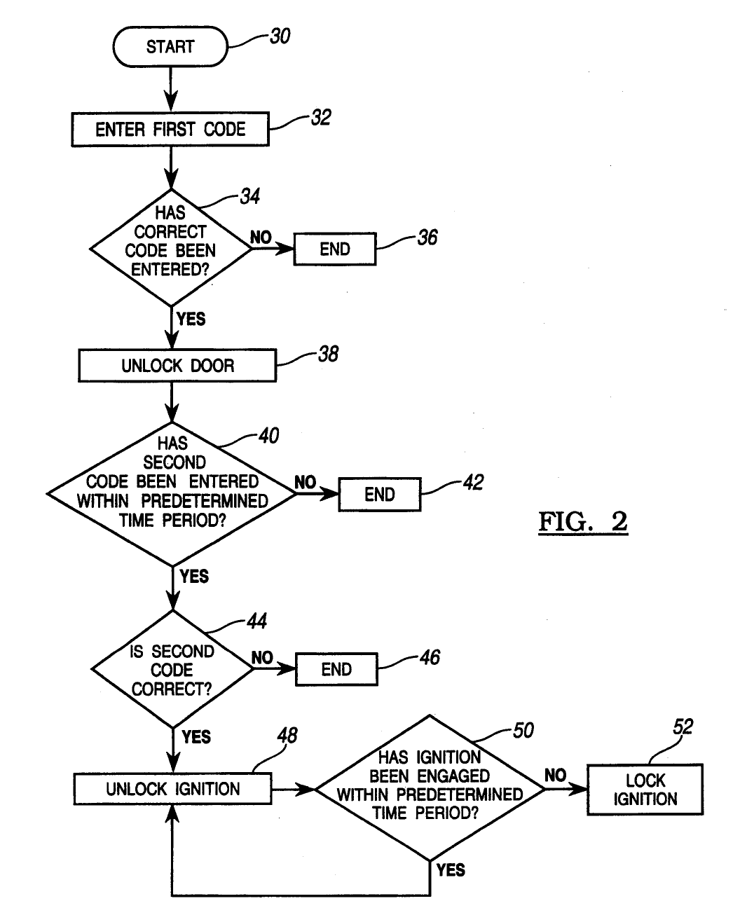

Now referring to FIG. 2, a flow chart of a method is illustrated in accordance with an embodiment of the present invention. A block 30 is an entry point into the method. Block 32 depicts a step wherein a first code may be entered. As described above, the codes may be entered via user input device 18 (FIG. 1). Following block 32, block 34 occurs wherein the control module determines whether a correct code has been entered. In one aspect of the invention, the code entered as depicted by block 32 is compared to codes that are stored within control module 20. If the control module determines that the entered code does not correspond with the stored codes, block 36 occurs, wherein the keyless entry program is terminated.

If the correct code has been entered, a block 38 occurs wherein the doors are unlocked. As depicted by block 40, the method includes a step of determining whether a second code has been entered within a predetermined time period. If a second code has not been entered within the second predetermined time period, the keyless entry operating method ends as depicted by block 42. However, if the second code is entered within the predetermined time period, the method determines whether the entered second code is correct, as depicted by block 44. If the second code entered is incorrect, the keyless operating system method ends as shown at block 46. Alternatively, if the second code entered is correct, the ignition of the vehicle is unlocked as depicted by block 48. Subsequent to block 48, a block 50 depicts the determination of whether the ignition has been engaged within a second predetermined time period. If the ignition has not been engaged within the second predetermined time period, the ignition enters the locked state as depicted by block 52.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A keyless operating system for a vehicle having an engine, the system comprising:
a user input device for receiving a first and a second user input;
a control module that communicates with the user input device and being configured to:
receive the first user input from the user input device,
determine whether the first user input corresponds to a first code, and
generate signals that enable vehicle entry if the first user input corresponds to the first code; and
wherein the control module is further configured to:
receive the second user input from the user input device,
determine whether the second user input corresponds to a second code, and
generate signals that enable starting of the vehicle engine if the second user input corresponds to the second code.

2. The system of claim 1, wherein the control module includes a timer for determining whether the second user input is received by the user input device within a first predetermined time period.

3. The system of claim 2, wherein the control module determines whether a process for starting the vehicle has commenced within a second predetermined time period, the control module generating signals to disable starting of the vehicle if the process for starting the vehicle has not commenced within the second predetermined time period.

4. The system of claim 3, wherein the process includes engaging an ignition of the vehicle.

5. The system of claim 1, wherein the control module being configured to generate signals that enable starting of the vehicle engine includes the control module being configured to generate signals for unlocking a vehicle ignition.

6. The system of claim 1, wherein the user input device is a keypad having at least one button that is mounted to the vehicle.

7. The system of claim 1, wherein the first code and the second code are stored within a memory of the control module.

8. A method of operation for a keyless operating system for a vehicle, wherein the vehicle has an engine, the method comprising:
receiving a first and a second user input from a user via a user input device;
determining whether the first user input corresponds to a first code through the use of a control module;
generating signals that enable vehicle entry if the first user input corresponds to the first code;
determining whether the second user input corresponds to a second code; and
generating signals that enable starting of the vehicle engine if the second user input corresponds to the second code.

9. The method of claim 8, further including determining whether the second user input is received by the user input device within a first predetermined time period through the use of a timer within the control module.

10. The method of claim 9, further including determining, via the control module, whether a process for starting the vehicle has commenced within a second predetermined time period; and
generating signals to disable starting of the vehicle if the process for starting the vehicle has not commenced within the second predetermined time period.

11. The method of claim 10, wherein the process includes engaging an ignition of the vehicle.

12. The method of claim 10, wherein generating signals to disable starting of the vehicle including generating signals that cause locking of an ignition located on the vehicle.

13. The method of claim 8, wherein generating signals that enable starting of the vehicle engine includes generating signals for unlocking a vehicle ignition.

14. The method of claim 8, wherein the user input device is a keypad having at least one button that is mounted to the vehicle.

15. The method of claim 8, further including storing the first code and the second code within a memory of the control module.
